(19) United States
(12) Patent Application Publication
(10) Pub. No.: US 2024/0380669 A1
(43) Pub. Date: Nov. 14, 2024

(54) METHOD AND SYSTEM OF CONNECTING TO A MULTIPATH HUB IN A CLUSTER

(71) Applicant: Nicira, Inc., Palo Alto, CA (US)

(72) Inventors: Ajit Ramachandra Mayya, Saratoga, CA (US); Parag Pritam Thakore, Los Gatos, CA (US); Stephen Craig Connors, San Jose, CA (US); Steven Michael Woo, Los Altos, CA (US); Sunil Mukundan, Chennai (IN); Nitin Kumar Ananda, Mountain View, CA (US)

(21) Appl. No.: 18/780,390

(22) Filed: Jul. 22, 2024

Related U.S. Application Data
(63) Continuation of application No. 17/827,972, filed on May 30, 2022, now Pat. No. 12,047,244.
Application No. 17/827,972 is a continuation of application No. 16/945,867, filed on Aug. 1, 2020, now Pat. No. 11,349,722.
Application No. 16/945,867 is a continuation of application No. 15/707,124, filed on Sep. 18, 2017, now Pat. No. 10,778,528.
(60) Provisional application No. 62/523,477, filed on Jun. 22, 2017.
(60) Provisional application No. 62/457,816, filed on Feb. 11, 2017.

(51) Int. Cl. H04L 41/12; H04L 9/40; H04L 12/46; H04L 41/0803; H04L 43/0811; H04L 43/0876; H04L 47/125

(52) U.S. Cl. CPC H04L 41/12; H04L 12/4633; H04L 41/0803; H04L 43/0811; H04L 43/0876; H04L 47/125; H04L 63/0272; H04L 63/029

(57) ABSTRACT

In one aspect, a computerized method useful for connecting to a multipath hub in a cluster includes the step of, with a gateway in a same network as the cluster, receiving, from a branch edge, a request to connect to a logical identifier (ID) of the multipath hub. The gateway recognizes a logical ID representing a cluster. The gateway determines a least-loaded edge in the cluster to be the multipath hub. The gateway returns a connectivity information for the multipath hub. The branch edge configures a tunnel to the multipath hub.

### CROSS REFERENCE TO RELATED APPLICATIONS

This application is a continuation application of U.S. patent application Ser. No. 17/827,972, filed May 30, 2022. U.S. patent application Ser. No. 17/827,972 is a continuation application of U.S. patent application Ser. No. 16/945,867, filed Aug. 1, 2020, now issued as U.S. Pat. No. 11,349,722. U.S. patent application Ser. No. 16/945,867 is a continuation application of U.S. patent application Ser. No. 15/707,124, filed Sep. 18, 2017, now issued as U.S. Pat. No. 10,778,528. U.S. patent application Ser. No. 15/707,124 claims priority to U.S. Provisional Patent Application No. 62/457,816, titled METHOD AND SYSTEM OF OVERLAY FLOW CONTROL, filed on Feb. 11, 2017. U.S. patent application Ser. No. 15/707,124 claims priority to U.S. Provisional Patent Application No. 62/523,477, titled METHOD AND SYSTEM OF RESILIENCY AND VISIBILITY IN CLOUD-DELIVERED SD-WAN, filed on Jun. 22, 2017. All of these applications and patents are incorporated herein by reference in their entireties for all purposes.

### FIELD OF THE INVENTION:

This application relates generally to computer networking, and more specifically to a system, article of manufacture and method connecting to a hub in a cluster.

### DESCRIPTION OF THE RELATED ART

Inherently, the size of a single VPN Network with a Hub may be constrained by the scale of the individual Hub. For large customers whose deployments reach twenty-thousand (20,000) sites, it may neither practical to scale an individual appliance to meet this scale nor mandate the customer manage individual separate Hubs to achieve this. In order to address this limitation, a clustering functionality can be used to easily expand the capacity of the Hub dynamically by creating a logical cluster, while also providing resiliency via the Active/Active HA topology that a cluster of Edges would provide. The Nodes in a Cluster can be either physical or virtual Edges. If they are virtual; they may exist on a single hypervisor or across hypervisors. The Edges within the cluster may communicate with the Gateway for control plane information and do not directly communicate nor exchange state.

### BRIEF SUMMARY OF THE INVENTION

In one aspect, a computerized method useful for connecting to a multipath hub in a cluster includes the step of, with a gateway in a same network as the cluster, receiving, from a branch edge, a request to connect to a logical Identifier (ID) of the multipath hub. The gateway recognizes a logical ID representing a cluster. The gateway determines a least-loaded edge in the cluster to be the multipath hub. The gateway returns a connectivity information for the multipath hub. The branch edge configures a tunnel to the multipath hub.

### BRIEF DESCRIPTION OF THE DRAWINGS

FIG. 1 illustrates an example process for connecting to a hub in a cluster, according to some embodiments.

FIG. 2 illustrates a system for implementing process 100, according to some embodiments.

FIG. 3 illustrates an example when a Branch Edge loses connectivity to a Hub of an Enterprise Data Center, according to some embodiments.

FIG. 4 where an Edge A sends traffic from Subnet A to Subnet B, according to some embodiments.

FIG. 5 illustrates an example enterprise data center, according to some embodiments.

FIG. 6 illustrates an example process for connecting when an edge loses connectivity to a hub, according to some embodiments.

FIG. 7 illustrates an example process of implementing aspects of step 602 or process 600, according to some embodiments.

FIG. 8 illustrates an example process for implementing aspects of step 610 and/or process 600, according to some embodiments.

FIG. 9 depicts an exemplary computing system that can be configured to perform any one of the processes provided herein.

The Figures described above are a representative set, and are not exhaustive with respect to embodying the invention.

### DESCRIPTION

Disclosed are a system, method, and article of manufacture for connecting to a multipath hub in a cluster. The following description is presented to enable a person of ordinary skill In the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to “one embodiment,” “an embodiment,” ‘one example,’ or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### DEFINITIONS

Example definitions for some embodiments are now provided.

Border Gateway Protocol (BGP) can be a standardized exterior gateway protocol designed to exchange routing and reachability information among autonomous systems (AS) on the Internet.

Dynamic tunneling can refer to Multi Path tunnels (i.e. paths) that are established on-demand between two endpoints when there is VPN traffic to be sent between two Edges, and torn down after VPN traffic is completed.

Edge device can be a device that provides an entry point into enterprise or service provider core networks. An edge device can be software running in a virtual machine (VM) located in a branch office and/or customer premises.

Enterprise Data Center can include multiple data centers (e.g. each with a duty of sustaining key functions).

Gateway can be a node (e.g. a router) on a computer network that serves as an access point to another network.

Internet Protocol Security (IPsec) can be a protocol suite for securing Internet Protocol (IP) communications by authenticating and encrypting each IP packet of a communication session.

Inter-process communication (IPC) can include mechanisms an operating system provides to allow the processes to manage shared data. Typically, applications can use IPC, categorized as clients and servers, where the client requests data and the server responds to client requests.

Orchestrator can include a software component that provides multi-tenant and role based centralized configuration management and visibility.

Subnet can be a logical subdivision of an IP network.

Tunneling protocol can allow a network user to access or provide a network service that the underlying network does not support or provide directly.

Virtual private network (VPN) can extend a private network across a public network, such as the Internet. It can enable users to send and receive data across shared or public networks as if their computing devices were directly connected to the private network, and thus benefit from the functionality, security and management policies of the private network.

Additional example definitions are provided herein.

### EXAMPLES SYSTEMS AND PROCESSES

A variety of techniques can be used to maintain branch connectivity to data centers, cloud applications, etc. For example, in a data center topology, an edge device (e.g. an edge) can be deployed in two different ways. As a cluster, redundancy can be provided for a single data center leveraging multiple independent devices. Alternately, redundancy can be provided by deploying multiple physical edges in multiple data centers that are interconnected via routing external to a gateway. In the clustering topology, each edge in a cluster can report health statistics to a gateway at a specified period (e.g. every 30 seconds, etc.). This can enable it to make intelligent decisions about assignment and rebalancing.

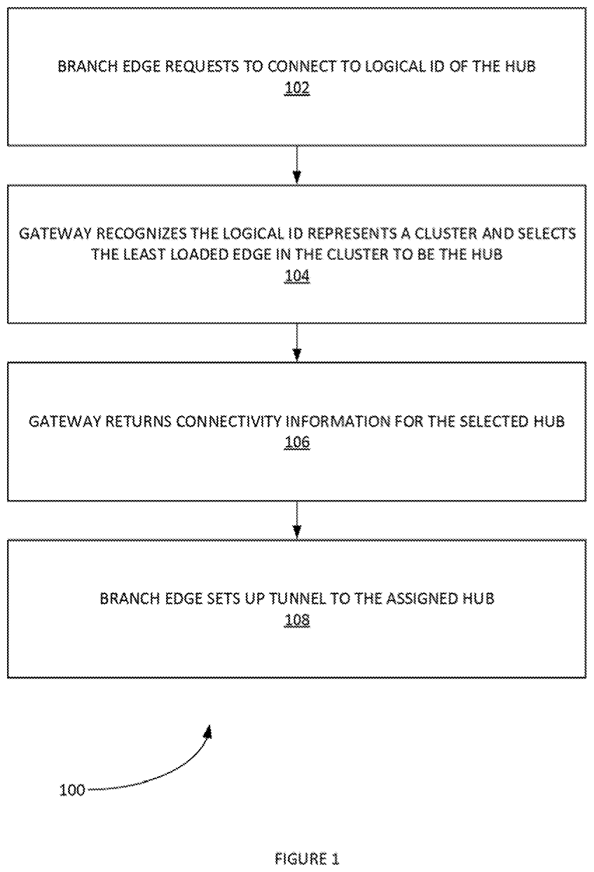

FIG. 1 illustrates an example process 100 for connecting to a multipath hub in a cluster, according to some embodiments. In step 102, a branch edge can request to connect to logical identifier (ID) of the multipath hub (e.g. a node with a large number of links, etc.). In step 104, the gateway recognizes the logical ID represents a cluster and selects the least loaded edge the cluster to be the multipath hub. In step 106, the gateway returns connectivity information for the selected multipath hub. In step 108, the branch edge sets up tunnel to the assigned multipath hub. Each measure of utilization is treated as a max out of one-hundred percent (100%). The tunnel count can be a maximum value based on the model number of the hardware model itself. The three (3) utilization percentages can be averaged to arrive at an integer number of utilization. The Edge with the lowest utilization number can be selected as the multipath hub. In case of a tie in lowest utilization score, a first Edge in the list with that score (e.g. the Edge which has been connected to the gateway the longest) can be selected. For example, on an Edge 1000: CPU 20%, Memory 30%, Tunnels 200 (out of 2000 max) Utilization score: (20+30+(20/2000))/3=20.

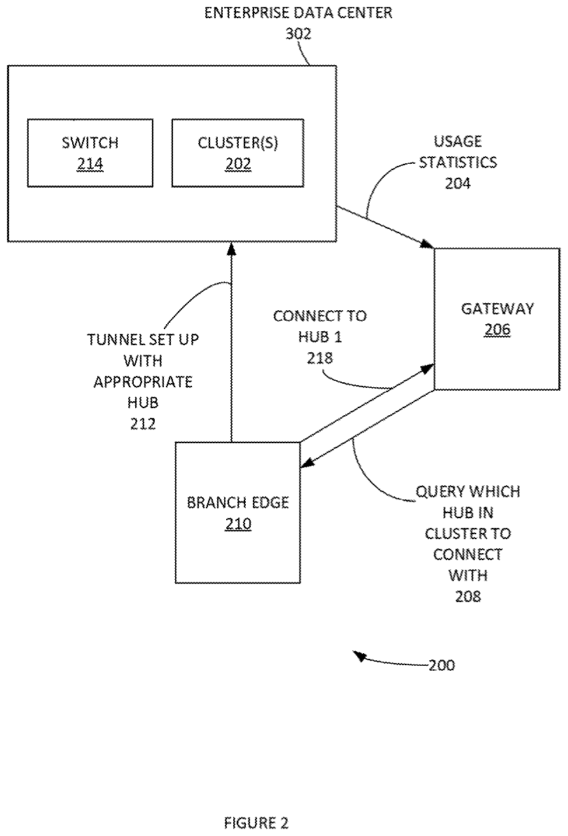

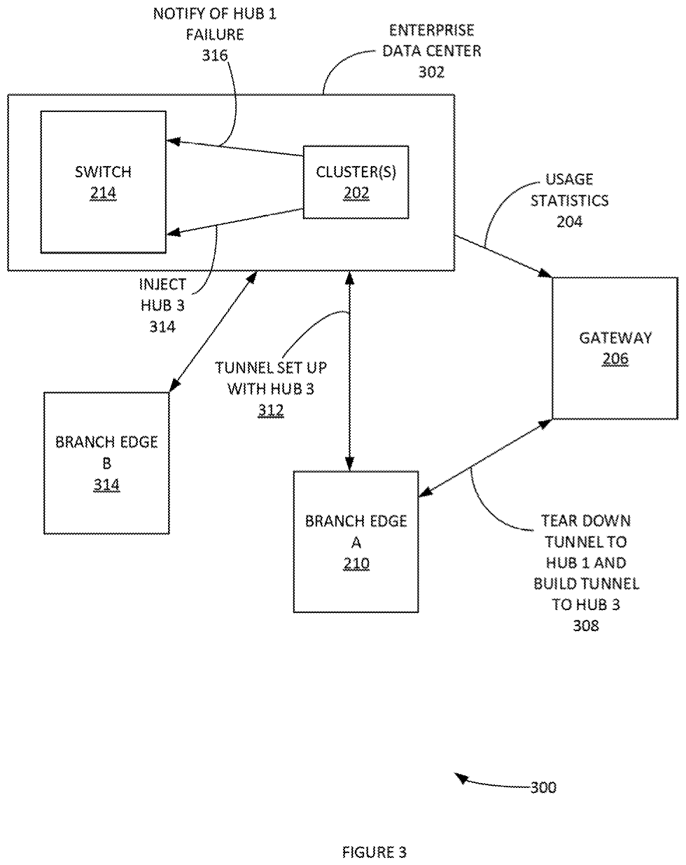

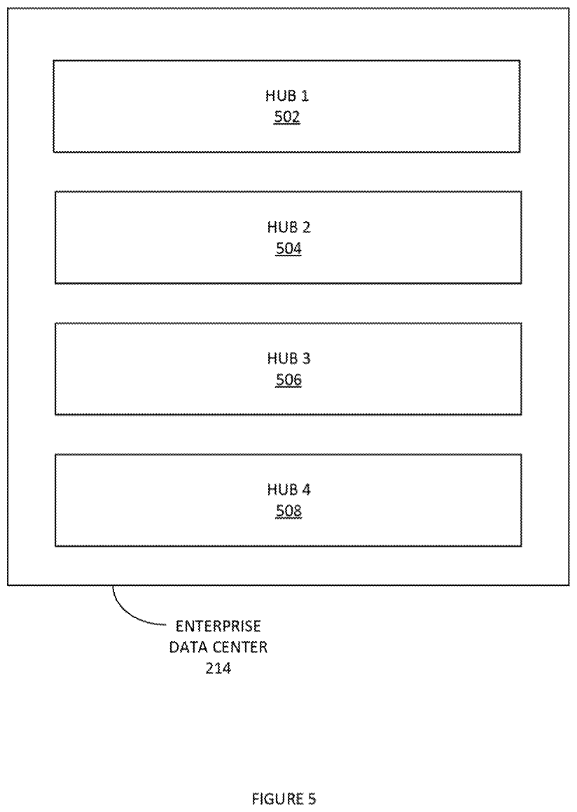

FIGS. 2 and 3 illustrate systems 200 and 300 for implementing process 100, according to some embodiments. Cluster(s) 202 can include various multipath hubs (e.g. Hubs 1-4 502-508 of FIG. 5, etc.). Cluster(s) 202 can communicate various network usage statistics 204 to cluster 206. Cluster(s) 202 can operate in an Enterprise Data Center 302. Branch Edge 210 can communicate a query which hub in cluster to connect with to cluster 206. Cluster 206 can communicate a specific hub identifier to Branch Edge 210 in step 214. Based on this information, branch edge 210 can set up a tunnel with appropriate hub in step 212. Switch 214 can be an L3 switch. Layer 3 switching can be based on (e.g. destination) IP address stored in the header of IP datagram.

FIG. 3 illustrates an example when a Stanch Edge 210 loses connectivity to a multipath Hub of an Enterprise Data Center, according to some embodiments. For example, all tunnels/paths connecting the Edge to the Hub disconnect and the Edge loses all means of connectivity to the Hub. It can again send a connection request to a gateway with the logical ID of Gateway 206, as if it were connecting for the first time. Since the gateway also has a list of connected hubs, if there was truly an outage, it may have also gone dead to the gateway and have been deleted from the list of available Edges that can be assigned from Gateway 206.

Even though in this use case Branch Edge(s) 210 and 314 may be connected to different Hubs in Gateway 206. Gateway 206 can signal the creation of Dynamic Edge-to-Edge tunnels in case both Branch Edge(s) 210 and 314 are not connected to the same Hub in Gateway 206. Gateway 206 can include a controller (not shown) that functions as a control plane piece of the Gateway 206.

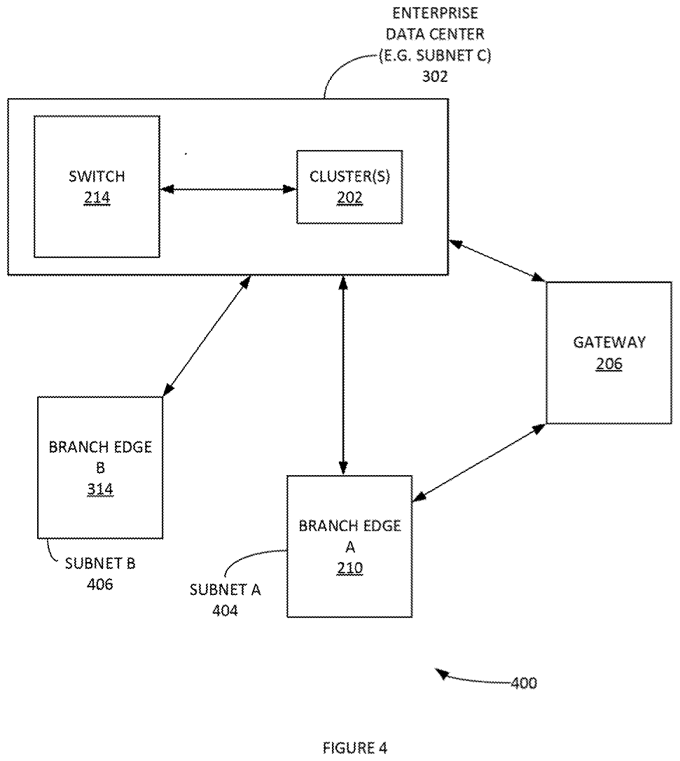

FIG. 4 where an Edge A 210 sends traffic from Subnet A 404 to Subnet B 406, according to some embodiments, Edge A 210 can send traffic from Subnet A 404 to Subnet B 406. Hub1 has learned the route for Edge B 314 from the L3 Switch 214 and advertised to Edge A 210 via a routing protocol (e.g. Velocloud® routing protocol (VCRP), etc.), Edgel sends the traffic to Hub1. Edgel can notify the gateway that it has initiated a connection to an IP in B. Traffic for B can be forwarded to the L3 Switch 214. L3 Switch 214 routes traffic to Hub3 as switch 214 has learned that route from Hub3 via a dynamic routing protocol (e.g. OSPF, BGP, etc.). Hub3 sends the traffic to Edge B 314 where it has learned the route for Edge B 314 via a routing protocol. Upon receipt of the message sent in process 100 supra, the gateway determines that Edge A 210 and Edge B 314 can directly connect. The gateway can notify Edge A 210 about connectivity information of Edge B 314. Gateway notifies Edge B 314 about connectivity information of Edge A 210. A dynamic tunnel can be established between Edge A 210 and Edge B 314. Traffic is moved to the direct tunnel and no longer traverses Cluster 206. It is noted that Cluster(s) 202 can operate in an Enterprise Data Center 302 (e.g. Subnet C).

FIG. 5 illustrates an example enterprise data center, according to some embodiments. By way of example, Enterprise data center 202 cart include one or more Hubs 1-4 502-508.

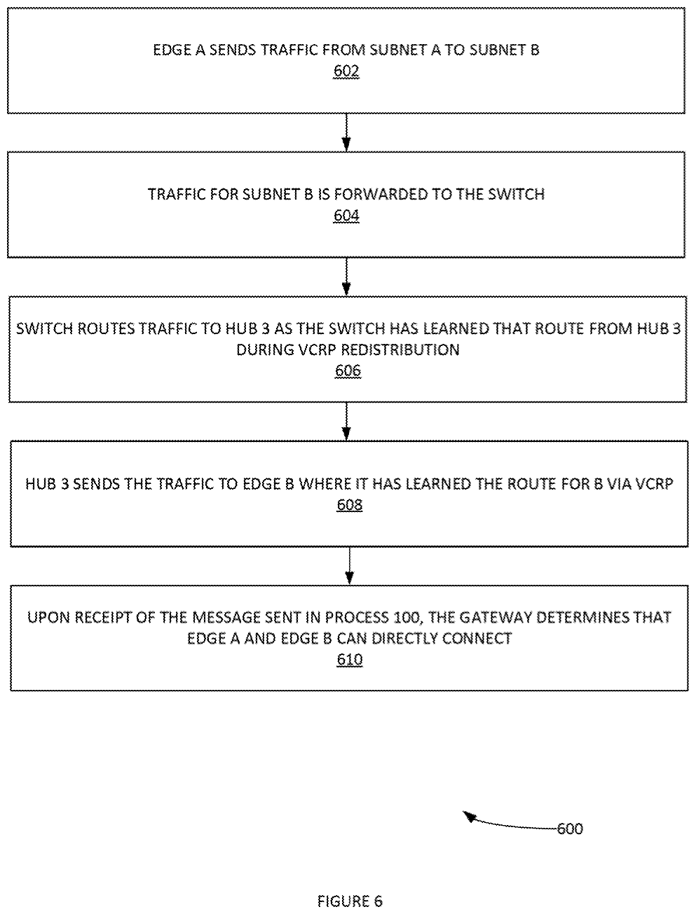

FIG. 6 illustrates an example process 600 for connecting when an edge loses connectivity to a hub, according to some embodiments. Process 600 can be implement with system 400 of FIG. 4 and system 500 of FIG. 5. For example, in step 602, Edge A 210 sends traffic from Subnet A 404 to Subnet B 406.

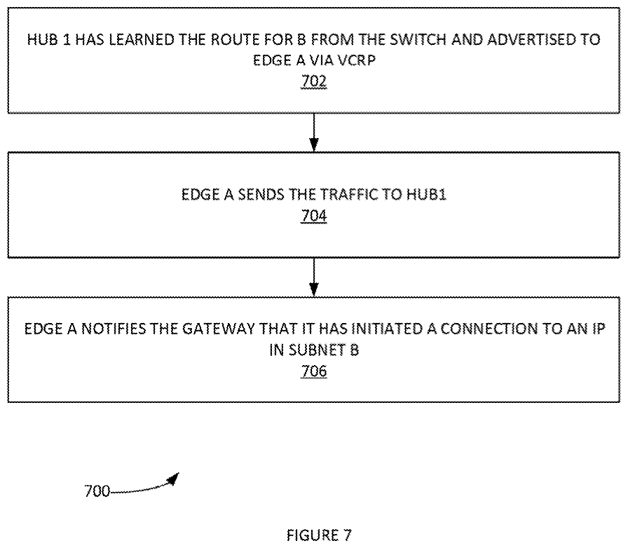

FIG. 7 illustrates an example process 700 of implementing aspects of step 602 or process 600, according to some embodiments. In step 702, Hub 1 502 has learned the route for Edge B 314 from the switch and advertised to Edge A 210 via a routing protocol. In step 704, Edge A 210 sends the traffic to Hub1 502. In step 706, Edge A 210 notifies the gateway that it has initiated a connection to an IP in Subnet B 406.

Returning to process 600, in step 604, traffic for Subnet B 406 is forwarded to the Switch 214. In step 606, the switch routes traffic to Hub 3 506 as the switch has learned that route from Hub 3 506 via a dynamic routing protocol (e.g. OSPF, BGP, etc.). In step 608, Hub 3 506 sends the traffic to Edge B where it has learned the route for B via a routing protocol.

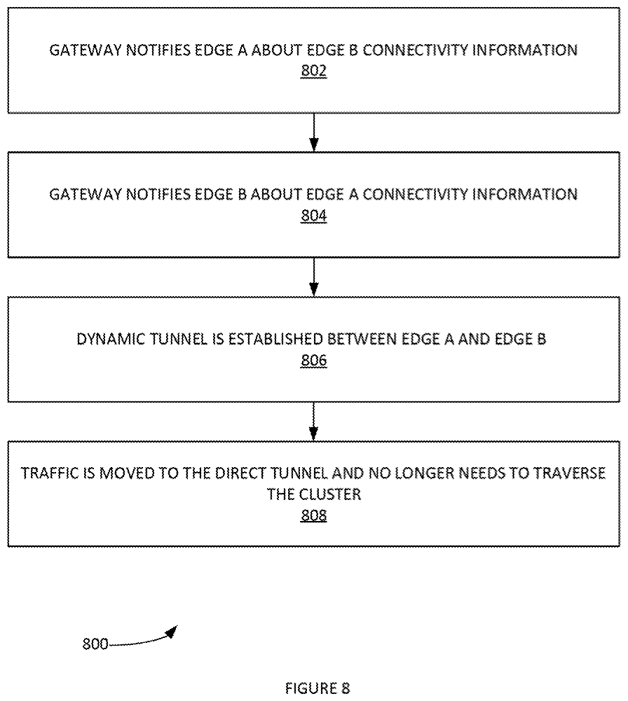

In step 610, upon receipt of the message sent in process 100, the gateway determines that Edge A 210 and Edge B 314 can directly connect. Edge A 210 and Edge B 314 are then connected. FIG. 8 illustrates an example process 800 for implementing aspects of step 610 and/or process 600, according to some embodiments. In step 802, a gateway notifies Edge A 210 about Edge B 314 connectivity information. In step 804, the gateway notifies Edge B 314 about the connectivity information of Edge A 210. In step 806, a dynamic tunnel is established between edge a and Edge B 314. In step 808, traffic is moved to the direct tunnel and no longer needs to traverse cluster 206.

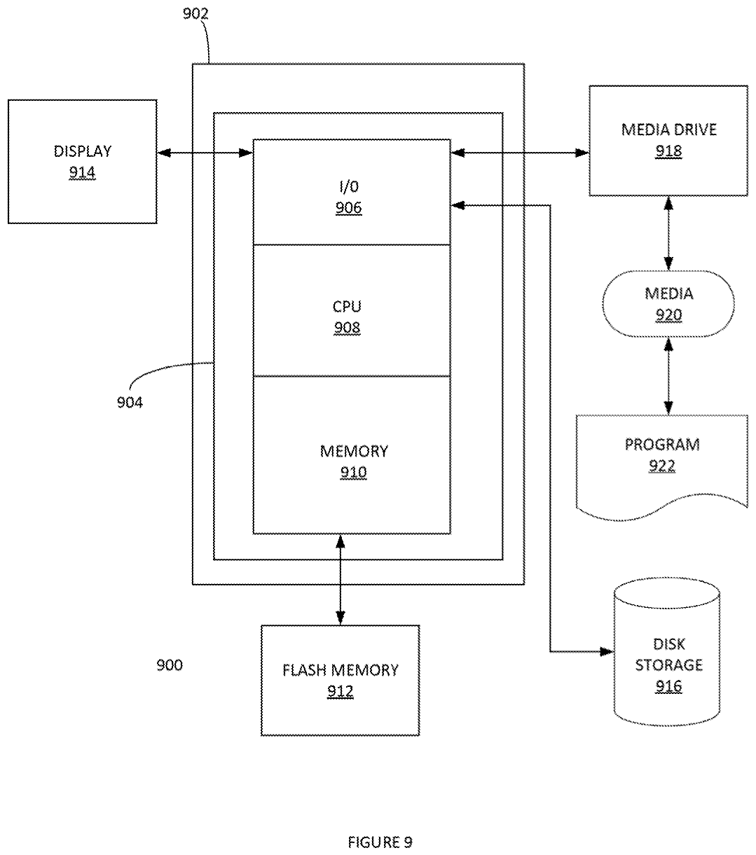

FIG. 9 depicts an exemplary computing system 900 that can be configured to perform any one of the processes provided herein. In this context, computing system 900 may include, for example, a processor, memory, storage, and I/O devices (e.g., monitor, keyboard, disk drive, Internet connection, etc.). However, computing system 900 may include circuitry or other specialized hardware for carrying out some or all aspects of the processes. In some operational settings, computing system 900 may be configured as a system that includes one or more units, each of which is configured to carry out some aspects of the processes either in software, hardware, or some combination thereof.

FIG. 9 depicts computing system 900 with a number of components that may be used to perform any of the processes described herein. The main system 902 includes a motherboard 904 having an I/O section 906, one or more central processing units (CPU) 908, and a memory section 910, which may have a flash memory card 912 related to it. The I/O section 906 can be connected to a display 914, a keyboard and/or other user input (not shown), a disk storage unit 916, and a media drive unit 918. The media drive unit 918 can read/write a computer-readable medium 920, which can contain programs 922 and/or data. Computing system 900 can include a web browser. Moreover, it is noted that computing system 900 can be configured to include additional systems in order to fulfill various functionalities. Computing system 900 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed is:

1. A method comprising:
detecting, by a branch edge device, a loss of connectivity to a multipath hub, the multipath hub being associated with a logical ID;
sending, by the branch edge device, a new connection request to a gateway with the logical ID of the multipath hub;
selecting, by the gateway, a new least loaded hub from a cluster of multipath hubs and returning a connectivity information for the new least loaded hub to the branch edge device; and
establishing, by the branch edge device, a tunnel connectivity with the new least loaded hub using the connectivity information.

2. The method of claim 1, wherein the gateway logs the connectivity status of each reestablished connection.

3. The method of claim 1, further comprising providing a notification for the loss of connectivity.

4. The method of claim 1, further comprising providing a notification for establishing the tunnel connectivity.

5. The method of claim 1, wherein the new connection request comprises updated utilization statistics of the branch edge device.

6. The method of claim 1, further comprising prioritizing the new least loaded hub based on a predetermined hierarchy for the cluster of multipath hubs.

7. The method of claim 1, wherein the connectivity information comprises security credentials for establishing the tunnel.

8. The method of claim 1, further comprising encrypting the connectivity information.

9. The method of claim 1, wherein the new least loaded hub is selected based on monitoring of hub utilization.

10. The method of claim 1, wherein the branch edge device adjusts its traffic routing policies based on the connectivity information.

11. A non-transitory machine readable medium storing a program executed by one or more processing units, the program comprising sets of instructions for:
detecting, by a branch edge device, a loss of connectivity to a multipath hub, the multipath hub being associated with a logical ID;
sending, by the branch edge device, a new connection request to a gateway with the logical ID of the multipath hub;
selecting, by the gateway, a new least loaded hub from a cluster of multipath hubs and returning a connectivity information for the new least loaded hub to the branch edge device; and
establishing, by the branch edge device, a tunnel connectivity with the new least loaded hub using the connectivity information.

12. The non-transitory machine readable medium of claim 11, wherein the gateway logs the connectivity status of each reestablished connection.

13. The non-transitory machine readable medium of claim 11, wherein the program further comprises instructions for providing a notification for the loss of connectivity.

14. The non-transitory machine readable medium of claim 11, wherein the program further comprises instructions for providing a notification for establishing the tunnel connectivity.

15. The non-transitory machine readable medium of claim 11, wherein the new connection request comprises updated utilization statistics of the branch edge device.

16. The non-transitory machine readable medium of claim 11, wherein the program further comprises instructions for prioritizing the new least loaded hub based on a predetermined hierarchy for the cluster of multipath hubs.

17. The non-transitory machine readable medium of claim 11, wherein the connectivity information comprises security credentials for establishing the tunnel.

18. The non-transitory machine readable medium of claim 11, wherein the program further comprises instructions for comprising encrypting the connectivity information.

19. The non-transitory machine readable medium of claim 11, wherein the new least loaded hub is selected based on monitoring a hub utilization.

20. The non-transitory machine readable medium of claim 11, wherein the branch edge device adjusts its traffic routing policies based on the connectivity information.
